(19) United States
(12) Patent Application Publication
(10) Pub. No.: US 2026/0106339 A1
(43) Pub. Date: Apr. 16, 2026

(54) SECONDARY BATTERY AND METHOD FOR MANUFACTURING SECONDARY BATTERY

(71) Applicant: SAMSUNG SDI CO., LTD., Yongin-si (KR)

(72) Inventor: Namyoul KIM, Yongin-si (KR)

(21) Appl. No.: 19/065,007

(22) Filed: Feb. 27, 2025

(30) Foreign Application Priority Data
Oct. 11, 2024 (KR) 10-2024-0138477

(51) Int. Cl. H01M 50/533; H01M 10/04; H01M 10/0587; H01M 50/109; H01M 50/153; H01M 50/16; H01M 50/548

(52) U.S. Cl. CPC H01M 50/533; H01M 10/049; H01M 10/0587; H01M 50/109; H01M 50/153; H01M 50/16; H01M 50/548

(57) ABSTRACT

A secondary battery, including an electrode assembly including a winding of a first electrode, a second electrode, and a separator between the first electrode and the second electrode, a case having an opening on one side, the case accommodating the electrode assembly, an electrode tab coupled with the first electrode, and a cap assembly configured to seal the opening by being coupled with the one side of the case, wherein the cap assembly includes an electrode terminal electrically connected to the electrode tab, the electrode terminal having a through hole through which the electrode tab passes, and an insulating cap connected to an outer peripheral surface of the electrode terminal and to be coupled to an inner peripheral surface of the case.

### CROSS-REFERENCE TO RELATED APPLICATION

This application claims priority under 35 U.S.C § 119 to Korean Patent Application No. 10-2024-0138477, filed in the Korean Intellectual Property Office on Oct. 11, 2024, the entire contents of which are hereby incorporated by reference.

### BACKGROUND

### 1. Field

Embodiments of the present disclosure relate to a secondary battery and a method for manufacturing a secondary battery.

### 2. Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments include a secondary battery, including an electrode assembly including a winding of a first electrode, a second electrode, and a separator between the first electrode and the second electrode, a case having an opening on one side, the case accommodating the electrode assembly, an electrode tab coupled with the first electrode, and a cap assembly configured to seal the opening by being coupled with the one side of the case, wherein the cap assembly includes an electrode terminal electrically connected to the electrode tab, the electrode terminal having a through hole through which the electrode tab passes, and an insulating cap connected to an outer peripheral surface of the electrode terminal and to be coupled to an inner peripheral surface of the case.

The through hole may have a shape corresponding to a cross-sectional shape of the electrode tab.

The electrode tab may be bent on an inside of the case, resulting in a bent electrode tab, the electrode tab being inserted into the through hole, and an outer peripheral surface of the bent electrode tab may be spaced apart from an inner peripheral surface of the through hole by a predetermined distance.

The electrode tab may be bent on an inside of the case, the electrode tab being inserted into the through hole, and one surface of the electrode tab adjacent to an inner surface of the electrode terminal may be coupled to the electrode terminal.

The electrode tab may be bent from an outside of the case, the electrode tab being coupled to an upper portion of the electrode terminal and sealing the through hole.

The electrode terminal may include a metal material.

A thickness of the cap assembly may be about 0.2 mm to about 0.25 mm.

The insulating cap may include a plastic material having insulating properties.

The plastic material may include at least one of polyethylene terephthalate, polyamide, and polycarbonate.

The insulating cap may be coupled to the inner peripheral surface of the case by heat fusion or laser welding.

Embodiments include a method of manufacturing a secondary battery, the method including preparing an electrode assembly configured by winding a first electrode, a second electrode, and a separator between the first electrode and the second electrode, connecting an electrode tab to the first electrode, accommodating the electrode assembly in a case having an opening formed on one side, bending one end of the electrode tab, resulting in a bent electrode tab, inserting an end of the bent electrode tab into a through hole formed in a cap assembly, coupling the bent electrode tab to an inner surface of the cap assembly, and coupling the cap assembly to one open side of the case.

Coupling the bent electrode tab may include disposing an outer peripheral surface of the bent electrode tab to be spaced apart by a predetermined distance from an inner peripheral surface of the through hole, the bent electrode tab being bent on an inside of the case and inserted into the through hole.

The method may further include, after coupling the cap assembly, applying electric current through the electrode tab and the case, and discharging gas generated inside the case to a space between the through hole and the electrode tab.

The method may further include bending the electrode tab from an outside of the case, coupling the electrode tab to an upper portion of an electrode terminal, and sealing the through hole after discharging the gas.

A thickness of the cap assembly may be about 0.2 mm to about 0.25 mm.

The method may further include electrically connecting an electrode terminal to the electrode tab, passing the electrode tab through a through hole in the electrode terminal, connecting an insulating cap to an outer peripheral surface of the electrode terminal, and coupling the insulating cap to an inner peripheral surface of the case.

The electrode terminal may include a metal material.

The insulating cap may be formed of a plastic material having insulating properties.

The plastic material may include at least one of polyethylene terephthalate, polyamide, and polycarbonate.

Coupling the electrode tab may include coupling one surface of the electrode tab, the one surface being adjacent to an inner surface of the electrode terminal, to the electrode tab, the electrode tab having been bent on an inside of the case and inserted into the through hole.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings.

Features will become apparent to those of ordinary skill in the art by describing in detail exemplary embodiments with reference to the attached drawings, in which:

FIG. 1 is a perspective view of a secondary battery according to one or more embodiments of the present disclosure;

FIG. 2 is an exploded perspective view of a secondary battery according to one or more embodiments of the present disclosure;

FIG. 3 is a cross-sectional view of a secondary battery according to one or more embodiments of the present disclosure;

FIG. 4 is a cross-sectional view of a cap assembly according to a comparative example;

FIG. 5 is a cross-sectional view of a cap assembly according to one or more embodiments of the present disclosure;

FIG. 6 is a view showing an example of a through hole shape of a cap assembly according to one or more embodiments of the present disclosure;

FIG. 7 is a view showing an electrode tab exposed to the outside through a through hole in a secondary battery according to one or more embodiments of the present disclosure;

FIG. 8 is a view showing that current is applied through the electrode tab and a case, and gas is discharged in the state of FIG. 7;

FIG. 9 is a view showing that the electrode tab is bent, and the through hole is sealed in the state of FIG. 8;

FIG. 10 is a flowchart showing a method for manufacturing a secondary battery according to one or more embodiments of the present disclosure; and

FIG. 11 is a flowchart showing a method for manufacturing a secondary battery including additional steps performed after the process of FIG. 10.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

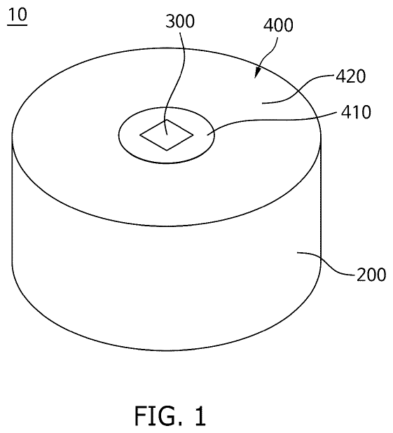

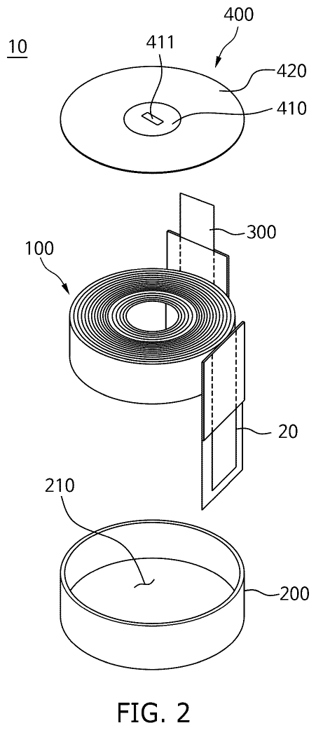

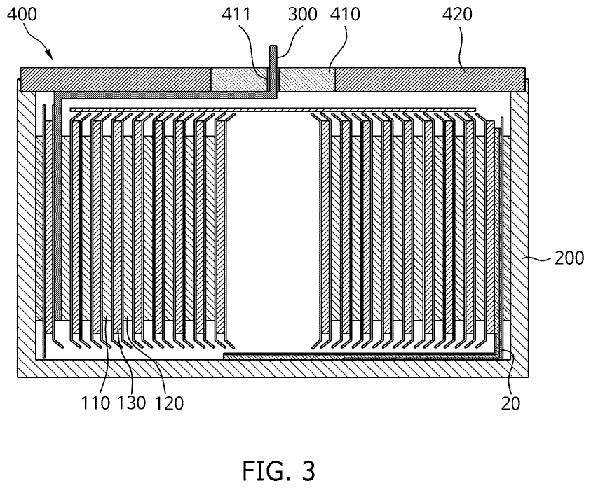

FIG. 1 is a perspective view of a secondary battery according to an embodiment of the present disclosure, FIG. 2 is an exploded perspective view of a secondary battery according to an embodiment of the present disclosure, and FIG. 3 is a cross-sectional view of a secondary battery according to an embodiment of the present disclosure.

As shown in FIGS. 1 to 3, a secondary battery 10 may include an electrode assembly 100, a case 200, an electrode tab 300, and a cap assembly 400.

In one or more embodiments, the secondary battery 10 may be a coin-type or button-type secondary battery. For example, the secondary battery 10 may have a cylindrical shape, but the shape of the secondary battery 10 may vary.

The electrode assembly 100 may include a first electrode 110, a second electrode 120, and a separator 130 therebetween. Specifically, the electrode assembly 100 may be configured by winding a first electrode 110, a second electrode 120, and a separator 130 interposed between the first electrode 110 and the second electrode 120. The electrode assembly 100 may be wound to form a core, and may include a hole in the core at the center.

The first electrode 110 may include a first substrate and a first active material layer disposed on the first substrate. The electrode tab 300 may extend outward from the first non-coated portion where the first active material layer is not located in the first substrate. The electrode tab 300 may be electrically connected to the cap assembly 400. In one or more embodiments, the electrode tab 300 may be a positive electrode tab. The electrode tab 300 may be combined with the first electrode 110.

The second electrode 120 may include a second substrate and a second active material layer disposed on the second substrate. A second electrode tab 20 may extend outward from a second non-coated portion where the second active material layer is not located in the second substrate, and the second electrode tab 20 may be electrically connected to the inner surface of the lower end of the case 200. In one or more embodiments, the second electrode tab 20 may be a negative electrode tab. The second electrode tab 20 may be combined with the second electrode 120. The electrode tab 300 and the second electrode tab 20 may extend in opposite directions from the first electrode 110 and the second electrode 120, respectively.

The first electrode 110 may function as a positive electrode. The positive electrode substrate may be composed of an aluminum foil, and the positive electrode active material may include, for example, a transition metal oxide. The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The second electrode 120 may function as a negative electrode. The negative electrode substrate may be composed of, for example, copper foil or nickel foil, and the negative electrode active material may include, for example, graphite.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a SiQ alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The separator 130 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and a combination thereof, but is not limited thereto.

The organic material and the inorganic material may be mixed in one coating layer, or a coating layer including an organic material and a coating layer including an inorganic material may be stacked.

In one or more embodiments, each of the electrode tab 300 and the second electrode tab 20 may be covered with a cover tape. The cover tape may contain an insulating material. Here, the insulating material may provide electrical insulation, thereby preventing the passing of current. A short circuit, which may occur between the electrode tab 300 and the second electrode tab 20, and conductive components adjacent to the electrode tab 300 and the second electrode tab 20, may be prevented by the cover tape.

For the purpose of explaining the present disclosure, the secondary battery is illustrated as a cylindrical secondary battery, but may include a secondary battery of any shape, such as a prismatic secondary battery, a pouch-type secondary battery, a coin-type secondary battery, etc.

In one or more embodiments, an opening 210 configured to accommodate the electrode assembly 100 may be formed at one side of the case 200. The case 200 accommodates the electrode assembly 100 and an electrolyte solution, and may form the outer shape of a secondary battery 10 together with the cap assembly 400. The case 200 may include a side wall portion having a roughly cylindrical shape and a bottom portion connected to one side of the side wall portion. However, the shape or structure of the case 200 may be configured in various shapes such as a circular type or a pouch type. Additionally, the case 200 may be formed of metal such as stainless steel, nickel-plated steel, or a laminate film or plastic that constitutes a pouch.

The case 200 may accommodate the electrode assembly 100. The electrode assembly 100 may be inserted through the opening 210 formed on one side of the case 200. Thereafter, the opening 210 of the case 200 may be sealed by the cap assembly 400. At this time, the electrode tab 300 may be inserted into the through hole 411.

The cap assembly 400 may be coupled to one side of the case 200. The cap assembly 400 may be coupled with one side of the case 200 to seal the opening 210. In an embodiment, the cap assembly 400 may include an electrode terminal 410 and an insulating cap 420. For example, the cap assembly 400 may be formed as a single-layer structure including an electrode terminal 410 in the central portion and an insulating cap 420 formed to surround the electrode terminal 410.

In one or more embodiments, the electrode terminal 410 may be electrically connected to the electrode tab 300. A through hole 411, through which the electrode tab 300 passes, may be formed in the electrode terminal 410. Specifically, the through hole 411 may be formed approximately at the center of the electrode terminal 410. At least a part of the electrode tab 300 may be inserted into the through hole 411.

The through hole 411 may be formed in a shape corresponding to the cross-sectional shape of the electrode tab 300. For example, the through hole 411 may be formed in a rectangular shape, which is the cross-sectional shape of the electrode tab 300. However, the through hole 411 may have any other appropriate shape through which the electrode tab 300 may penetrate.

The electrode terminal 410 may include a metal material. For example, the electrode terminal 410 may be formed of aluminum (Al). However, other appropriate materials having a conductivity may also be used. The electrode tab 300 may be bent inside the case 200 and may be inserted into the through hole 411. In a state that the electrode tab 300 is inserted into the through hole 411, the outer peripheral surface of the bent electrode tab 300 may be disposed to be spaced apart from the inner peripheral surface of the through hole 411 by a predetermined distance. Therefore, the inner space of the case 200 may be unsealed.

In a state that the electrode tab 300 has been bent on the inside of the case 200 and has been inserted into the through hole 411, one surface of the electrode tab 300 adjacent to the inner surface of the electrode terminal 410 may be coupled to the electrode terminal 410. Through this, the electrode tab 300 combined with the first electrode 110 may be electrically connected to the electrode terminal 410. For example, referring to FIG. 3, even though the electrode tab 300 is spaced apart from the lateral surface of the electrode terminal 410 inside the through hole 411, the electrode tab 300 is still in direct contact with the bottom surface of the electrode terminal 410 that faces the interior of the case 200.

In an embodiment, the insulating cap 420 may be connected to the outer peripheral surface of the electrode terminal 410 and coupled to the inner peripheral surface of the case 200. For example, the insulating cap 420 may have a disk or ring shape with a hole in the center. An electrode terminal 410 may be disposed at the center of the insulating cap 420, so that a single-layer cap assembly 400 may be formed.

The insulating cap 420 may include a plastic material having insulating properties (e.g., electrical insulating properties). In one or more embodiments, the plastic material may include at least one of polyethylene terephthalate, polyamide, and polycarbonate.

The cap assembly 400 may be closely coupled in an area where the cap assembly 400 contacts or is coupled to the terminal of the opening 210 of the case 200. For example, the insulating cap 420 may be joined to the inner peripheral surface of the opening 210 of the case 200 by heat fusion or laser welding. For example, the insulating cap 420 may be welded to the opening 210 of the case 200 using any one of ultrasonic welding, resistance welding, tungsten inert gas welding (TIG welding), or a combination thereof. The welding method is not limited to the types of welding listed above, and various methods commonly used for welding two materials may be used according to the choice of a person skilled in the art.

The insulating cap 420 may be coupled to the opening 210 to seal the opening 210 of the case 200. The insulating cap 420 may be coupled with the side of the case 200 corresponding to the side of the opening 210.

In one or more embodiments, a part of the electrode tab 300, which protrudes outward from the case 200 through the through hole 411, may be bent and joined to the upper portion of the electrode terminal 410. For example, the electrode tab 300 exposed to the outside of the case 200 may be bent to be surface-joined to the upper surface of the electrode terminal 410 to seal the through hole 411.

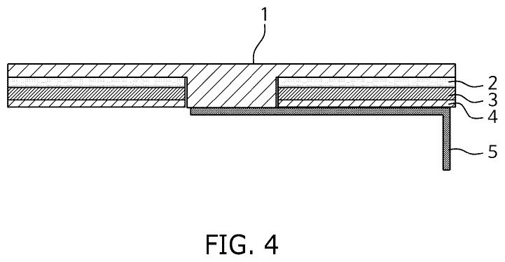

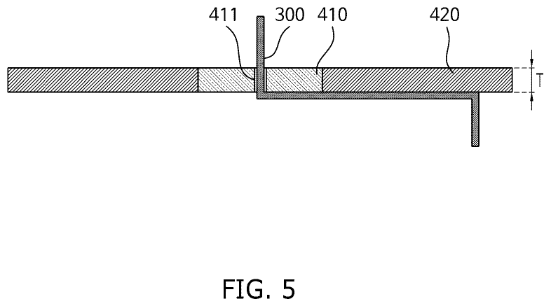

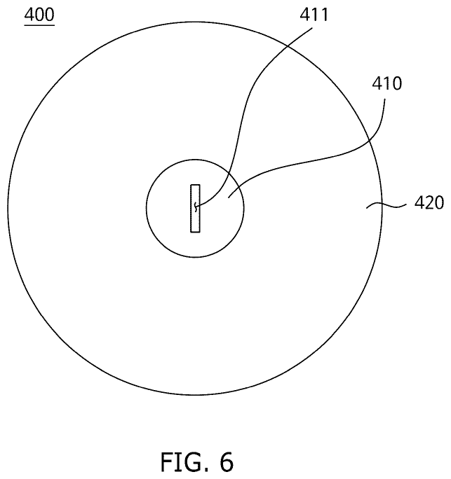

FIG. 4 is a cross-sectional view of a cap assembly according to a comparative example, FIG. 5 is a cross-sectional view of a cap assembly according to an embodiment of the present disclosure, and FIG. 6 is a view showing an example of a through hole shape of a cap assembly according to an embodiment of the present disclosure.

According to the comparative example illustrated in FIG. 4, the cap assembly includes a terminal plate 1 formed of aluminum (Al), a cap plate 3 formed of stainless steel, an insulating layer 2 that acts as an insulator between the terminal plate 1 and the cap plate 3, and a washer 4. Here, the washer 4 acts as an insulator between the cap plate 3 and the positive electrode tab 5.

According to the comparative example, during the manufacturing process of the cap assembly, metal foreign materials may penetrate into the interior of the insulating layer 2. As such, in a state that the metal foreign substance is included in the insulating layer 2, if the upper and lower direction pressure is applied to the secondary battery, the metal foreign substance may cause conduction between the terminal plate 1 and the cap plate 3. Additionally, the multilayer cap assembly composed of a terminal plate 1, an insulating layer 2, a cap plate 3 and a washer 4 may have a considerable thickness. As a result, the volume of the electrode assembly accommodated inside the secondary battery case of the same size may be reduced, and accordingly, it may be difficult to secure sufficient energy density.

Referring to FIG. 5, a cap assembly 400 according to one or more embodiments of the present disclosure may be formed as a single-layer structure including an electrode terminal 410 and an insulating cap 420 surrounding the electrode terminal. Accordingly, the thickness (T) of the cap assembly 400 may be reduced, and the volume of the electrode assembly accommodated inside a secondary battery case of the same size may be increased. This allows the capacity of the electrode assembly that may be accommodated inside the case to be increased, thereby increasing the energy density of the secondary battery.

For example, the thickness (T) of the cap assembly 400 may be about 0.2 mm to about 0.25 mm. If the thickness (T) of the cap assembly 400 is less than 0.2 mm, a short circuit may occur because sufficient rigidity is not secured when an impact is applied from the outside of the secondary battery. If the thickness (T) of the cap assembly 400 exceeds 0.25 mm, it may be difficult to secure the internal space of the case, which may limit the ability to increase the energy density of the secondary battery.

As shown in FIG. 6, the shape of the through hole 411 when viewed from above may be rectangular. The shape of the through hole 411 may vary, as long as it is a shape that allows the internal space and the external space of the case 200 to be connected in a state that the electrode tab 300 has been inserted into the through hole 411.

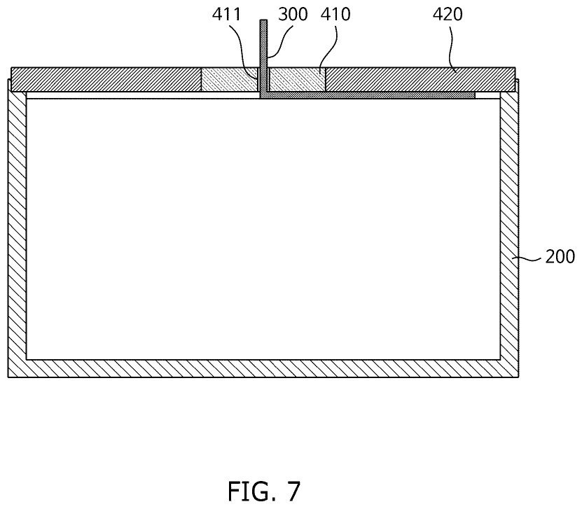

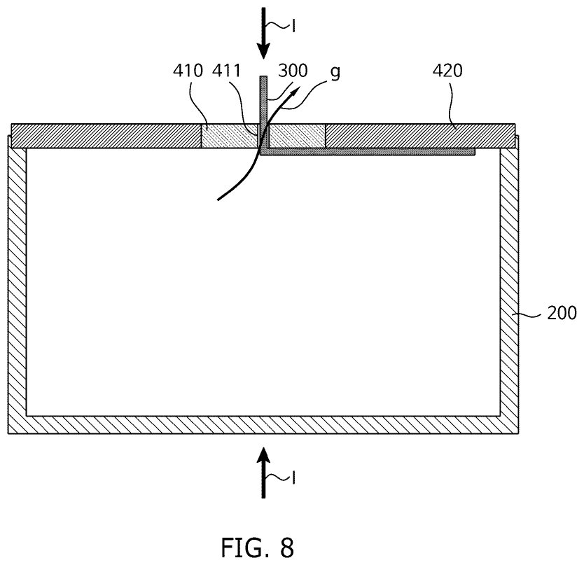

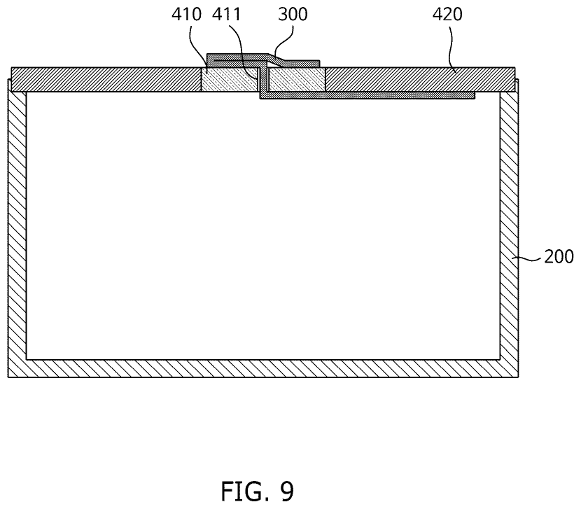

FIG. 7 is a view showing an electrode tab exposed to the outside through a through hole in a secondary battery according to an embodiment of the present disclosure, FIG. 8 is a view showing that current is applied through the electrode tab and a case, and gas is discharged in the state of FIG. 7, and FIG. 9 is a view showing that the electrode tab is bent, and the through hole is sealed in the state of FIG. 8.

In one or more embodiments, in a state that the electrode tab 300 has been bent inside the case 200 and has been inserted into the through hole 411, the outer peripheral surface of the bent electrode tab 300 and the inner peripheral surface of the through hole 411 may be spaced apart by a predetermined distance. In this state, when current (I) is applied through the electrode tab 300 and the case 200, gas (g) may be generated in the inner space of the case 200. The gas (g) generated in the inner space of the case 200 may be discharged to the outside of the case 200 through a space between the electrode tab 300 and the through hole 411.

After the gas (g) generated inside the case (200) is discharged to the outside, a part of the electrode tab 300 exposed to the outside through the through hole 411 may be bent to seal the through hole 411 of the electrode terminal 410. An upper portion of the electrode terminal is a surface of the electrode terminal facing away from the interior of the case. For example, the insulating cap 420 may be coupled to one side of the case 200, and the electrode tab 300 may be bent from the outside of the case 200 and coupled to the upper surface of the electrode terminal 410. Through this, the electrode tab 300 seals the through hole 411, and the internal space of the case 200 may be completely sealed.

The electrode tab 300 may be bent on the outside of the case 200 and be surface-joined to the upper surface of the electrode terminal 410. At this time, the electrode tab 300 may be bent so as not to come into contact with the insulating cap 420. The bent electrode tab 300 may be exposed to the outside of the case 200 and serve as a terminal connected to an external terminal.

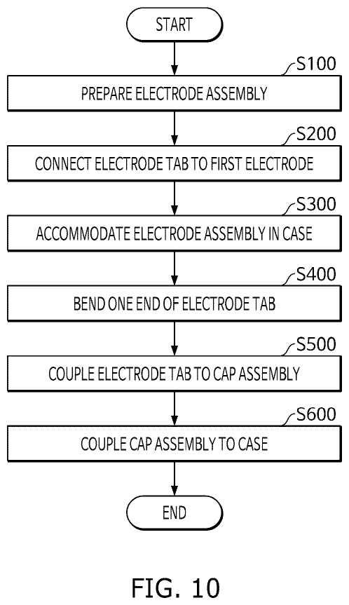

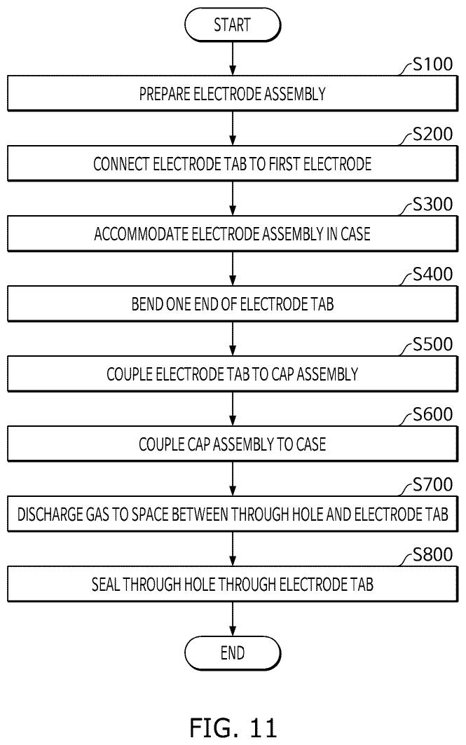

FIG. 10 is a flowchart showing a method for manufacturing a secondary battery according to an embodiment of the present disclosure, and FIG. 11 is a flowchart showing a method for manufacturing a secondary battery including additional steps performed after the process of FIG. 10.

Referring to FIGS. 10 and 11, a method for manufacturing a secondary battery according to one or more embodiments of the present disclosure may include a step of preparing an electrode assembly (S100), a step of connecting an electrode tab to a first electrode (S200), a step of accommodating the electrode assembly in a case (S300), a step of bending one end of the electrode tab (S400), a step of connecting the electrode tab to a cap assembly (S500), and a step of connecting the cap assembly to the case (S600).

First, the method for manufacturing a secondary battery may begin with a step of preparing an electrode assembly (S100). In the step of preparing an electrode assembly (S100), the electrode assembly may be configured by winding a first electrode, a second electrode, and a separator interposed between the first electrode and the second electrode. After the step of preparing the electrode assembly (S100), the step of connecting the electrode tab to the first electrode (S200) may be performed.

After the step of connecting the electrode tab to the first electrode (S200), the step of accommodating the electrode assembly in the case (S300) may be performed. In the step of accommodating the electrode assembly (S300), the electrode assembly may be accommodated in a case having an opening formed on one side. An opening configured to accommodate an electrode assembly may be formed on one side of the case, and the electrode assembly and the electrolyte may be accommodated in the internal space.

In one or more embodiments, in the step of bending one end of the electrode tab (S400), the electrode tab may be bent on the inside of the case. For example, in the step of bending one end of the electrode tab (S400), one surface of the electrode tab adjacent to the inner surface of the electrode terminal may be bent at about 90 degrees so as to come into contact with the electrode terminal.

After the step of bending one end of the electrode tab (S400), the step of joining the electrode tab to the cap assembly (S500) may be performed. In the step of coupling the electrode tab to the cap assembly (S500), one end of the electrode tab bent in the through hole formed in the cap assembly may be inserted, and the electrode tab may be coupled to the inner surface of the cap assembly.

The step of coupling electrode tabs (S500) may include a step of disposing the outer peripheral surface of the bent electrode tab to be spaced apart by a predetermined distance from the inner peripheral surface of the through hole while the electrode tab is bent on the inside of the case and inserted into the through hole. The thickness of the cap assembly may be from 0.2 mm to 0.25 mm. In one or more embodiments, the cap assembly may include an electrode terminal, which is electrically connected to an electrode tab and has a through hole through which the electrode tab passes, and an insulating cap, which is connected to the outer peripheral surface of the electrode terminal and coupled to the inner peripheral surface of the case. For example, the electrode terminal may include a metal material. In contrast, the insulating cap may be formed from a plastic material having insulating properties. For example, the plastic material may include at least one of polyethylene terephthalate, polyamide, and polycarbonate.

In the step of coupling an electrode tab (S500), the electrode tab may be coupled with an electrode terminal. The step of joining the electrode tab (S500) may include a step of coupling one surface of the electrode tab adjacent to the inner surface of the electrode terminal to the electrode terminal in a state that the electrode tab has been bent on the inside of the case and inserted into the through hole.

After the step of coupling the electrode tabs (S500), the step of coupling the cap assembly to the case (S600) may be performed. In the step of coupling the cap assembly to the case (S600), the cap assembly may be coupled to one side of the case. That is, the cap assembly may be combined with one side of the case to seal the opening.

In one or more embodiments, after the step of coupling the cap assembly to the case (S600), a step of discharging gas to an area between the through hole and the electrode tab (S700) may be further performed. The step of discharging gas (S700) may include a step of applying current through the electrode tab and the case, and discharging gas generated in the internal space of the case through a space between the through hole and the electrode tab.

After the gas discharge step (S700), a step of sealing the through hole through the electrode tab (S800) may be further performed. The step of sealing the through hole (S800) may include a step of bending the electrode tab from the outside of the case and coupling the electrode tab to the upper portion of the electrode terminal, and sealing the through hole. For example, in the step of sealing the through hole (S800), the electrode tab exposed to the outside of the case may be bent to be surface-joined to the upper surface of the electrode terminal. Through this, the through hole formed in the electrode terminal may be sealed.

The flowcharts of FIGS. 10 and 11 and the above description are only examples of the present disclosure. For example, one or more steps in flowcharts and/or the above description may be added/changed/deleted, the order of one or more steps may be changed, and one or more steps may be performed simultaneously.

In small secondary batteries such as coin cells, a cap assembly includes a terminal plate formed of aluminum (Al), a cap plate formed of stainless steel, and an insulating layer that acts as an insulator between the terminal plate and the cap plate. However, when a secondary battery was subjected to upward and downward pressure in a state a metal foreign material entered the inside of the insulating layer during the manufacturing process of the cap assembly, there was a problem that conduction occurred between the terminal plate and the cap plate due to the metal foreign material. In addition, when assembling the secondary battery, the case and cap assembly are sealed by welding, but there was a problem in that the internal pressure of the secondary battery increased because there was no vent structure to discharge the gas generated during the initial activation of the secondary battery in the formation process after the assembly.

According to various embodiments of the present disclosure, the structure of a multilayer cap assembly in a secondary battery may be changed to a single-layer structure in which an electrode terminal and an insulating cap are combined, thereby preventing a short circuit that may occur due to a metal foreign substance existing between the multilayer structures.

According to various embodiments of the present disclosure, the thickness of the cap assembly can be reduced by simplifying a multilayer structure of the cap assembly into a single layer structure. Through this, the volume of the electrode assembly accommodated inside a secondary battery case of the same size can be increased, and the energy density of the secondary battery can be increased.

According to various embodiments of the present disclosure, gas generated in the initial activation stage of an active material can be discharged into a space between an electrode terminal and an electrode tab, and the internal pressure of a secondary battery can be reduced to improve stability.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is

1. A secondary battery, comprising:
an electrode assembly including a winding of a first electrode, a second electrode, and a separator between the first electrode and the second electrode;
a case having an opening on one side, the case accommodating the electrode assembly;
an electrode tab coupled with the first electrode; and
a cap assembly configured to seal the opening by being coupled with the one side of the case,
wherein the cap assembly comprises:
an electrode terminal electrically connected to the electrode tab, the electrode terminal having a through hole through which the electrode tab passes; and
an insulating cap connected to an outer peripheral surface of the electrode terminal and to be coupled to an inner peripheral surface of the case.

2. The secondary battery as claimed in claim 1, wherein the through hole has a shape corresponding to a cross-sectional shape of the electrode tab.

3. The secondary battery as claimed in claim 1, wherein:
the electrode tab is bent on an inside of the case, resulting in a bent electrode tab, the electrode tab being inserted into the through hole, and
an outer peripheral surface of the bent electrode tab is spaced apart from an inner peripheral surface of the through hole by a predetermined distance.

4. The secondary battery as claimed in claim 1, wherein:
the electrode tab is bent on an inside of the case, the electrode tab being inserted into the through hole, and
one surface of the electrode tab adjacent to an inner surface of the electrode terminal is coupled to the electrode terminal.

5. The secondary battery as claimed in claim 1, wherein the electrode tab is bent from an outside of the case, the electrode tab being coupled to an upper portion of the electrode terminal and sealing the through hole.

6. The secondary battery as claimed in claim 1, wherein the electrode terminal comprises a metal material.

7. The secondary battery as claimed in claim 1, wherein a thickness of the cap assembly is about 0.2 mm to about 0.25 mm.

8. The secondary battery as claimed in claim 1, wherein the insulating cap comprises a plastic material having insulating properties.

9. The secondary battery as claimed in claim 8, wherein the plastic material comprises at least one of polyethylene terephthalate, polyamide, and polycarbonate.

10. The secondary battery as claimed in claim 1, wherein the insulating cap is coupled to the inner peripheral surface of the case by heat fusion or laser welding.

11. A method of manufacturing a secondary battery, the method comprising:
preparing an electrode assembly configured by winding a first electrode, a second electrode, and a separator between the first electrode and the second electrode;
connecting an electrode tab to the first electrode;
accommodating the electrode assembly in a case having an opening formed on one side;
bending one end of the electrode tab, resulting in a bent electrode tab;
inserting an end of the bent electrode tab into a through hole formed in a cap assembly;
coupling the bent electrode tab to an inner surface of the cap assembly; and
coupling the cap assembly to one open side of the case.

12. The method as claimed in claim 11, wherein coupling the bent electrode tab comprises disposing an outer peripheral surface of the bent electrode tab to be spaced apart by a predetermined distance from an inner peripheral surface of the through hole, the bent electrode tab being bent on an inside of the case and inserted into the through hole.

13. The method as claimed in claim 12, further comprising, after coupling the cap assembly, applying electric current through the electrode tab and the case, and discharging gas generated inside the case to a space between the through hole and the electrode tab.

14. The method as claimed in claim 13, further comprising:
bending the electrode tab from an outside of the case;
coupling the electrode tab to an upper portion of an electrode terminal; and
sealing the through hole after discharging the gas.

15. The method as claimed in claim 11, wherein a thickness of the cap assembly is about 0.2 mm to about 0.25 mm.

16. The method as claimed in claim 11, further comprises:
electrically connecting an electrode terminal to the electrode tab;
passing the electrode tab through a through hole in the electrode terminal;
connecting an insulating cap to an outer peripheral surface of the electrode terminal; and
coupling the insulating cap to an inner peripheral surface of the case.

17. The method as claimed in claim 16, wherein the electrode terminal comprises a metal material.

18. The method as claimed in claim 16, wherein the insulating cap is formed of a plastic material having insulating properties.

19. The method as claimed in claim 18, wherein the plastic material comprises at least one of polyethylene terephthalate, polyamide, and polycarbonate.

20. The method as claimed in claim 16, wherein coupling the electrode tab comprises coupling one surface of the electrode tab, the one surface being adjacent to an inner surface of the electrode terminal, to the electrode tab, the electrode tab having been bent on an inside of the case and inserted into the through hole.
